(19) United States
(12) Patent Application Publication
(10) Pub. No.: US 2007/0208439 A1
(43) Pub. Date: Sep. 6, 2007

(54) Support for flexible integration of an industrial process simulation system with a control system

(75) Inventors: David S. Driskill, Greenville, SC (US); Steven D. Morrison, Piedmont, SC (US); Richard L. Froehlich, Lincoln, NE (US)

Correspondence Address: WESTMAN CHAMPLIN & KELLY, P.A., SUITE 1400, 900 SECOND AVENUE SOUTH, MINNEAPOLIS, MN, 55402-3319, US

(73) Assignee: Velociti Alliance North America, Inc., Greenville, SC (US)

(21) Appl. No.: 11/709,181

(22) Filed: Feb. 21, 2007

Related U.S. Application Data
(60) Provisional application No. 60/778,882, filed on Mar. 3, 2006.

(51) Int. Cl. G05B 19/42

(52) U.S. Cl. 700/86

(57) ABSTRACT

A computer implemented method is disclosed for facilitating communication within an industrial application environment. The method includes receiving a signal from an industrial application simulation system. The signal is converted into a different format that is recognizable by a component that is outside of the industrial application simulation system.

The present application is based on and claims the benefit of U.S. Provisional Patent Application Ser. No. 60/778,882, filed on Mar. 3, 2006, the content of which is hereby incorporated by reference in its entirety.

### BACKGROUND

There are known control systems such as a programmable logic controller (PLC) that are configured to support the automation of industrial processes. There are also simulation systems that enable the connection of a control system to a simulated industrial process, which can reduce controls commissioning time when the time comes for integration with a real world industrial application. Unfortunately, simulation systems commonly require implementation of complex software drivers that are specific to the type of control system used. For at least this reason, there is a need for a more flexible and convenient way to integrate an industrial process simulation system with a control system.

### SUMMARY

A computer implemented method is disclosed for facilitating communication within an industrial application environment. The method includes receiving a signal from an industrial application simulation system. The signal is converted into a different format that is recognizable by a component that is outside of the industrial application simulation system.

### BRIEF DESCRIPTION OF THE DRAWINGS

FIG. 1 is a schematic diagram of an industrial process environment.

FIG. 2 is a schematic diagram of an example implementation of a hardware component included in the industrial process environment.

FIGS. 3-6 are examples of user interface components.

### DETAILED DESCRIPTION

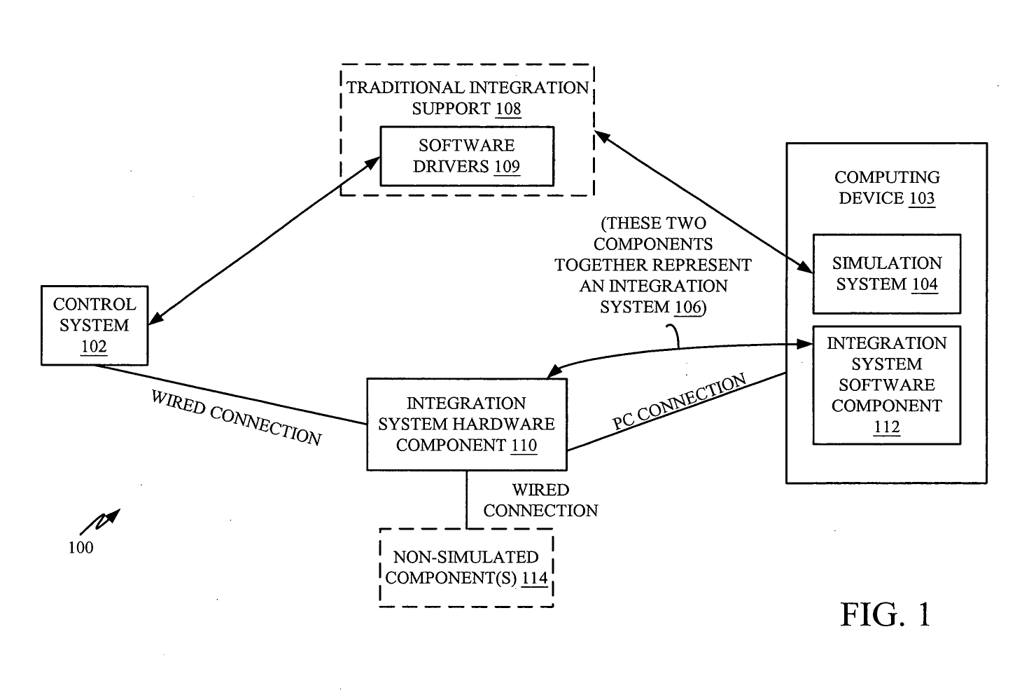

FIG. 1 is a schematic diagram of a suitable industrial process environment 100 in which embodiments may be implemented. Environment 100 is only one example of a suitable environment and is not intended to suggest any limitation as to the scope of use or functionality of the claimed subject matter. Neither should environment 100 be interpreted as having any dependency or requirement relating to any one or combination of illustrated components.

Environment 100 includes a control system 102. Control system 102 is illustratively, though not necessarily, a programmable logic controller (PLC). Examples of PLC's include, but certainly are not limited to, at least some of the products marketed under the “SIMATIC” brand by Siemens Energy and Automation, Inc. (Siemens) of Alpharetta, Ga. Control system 102 can be a traditional PLC or one of the so-called “soft” PLC systems currently available on the market from a variety of different product sources including Siemens. It should be emphasized that control system 102 is not limited to being a PLC system. Other types of control systems should be considered within the scope of the present invention.

Environment 100 also includes a simulation system 104, which, generally speaking, is a software application implemented on a computing device 103 (e.g., a PC). Simulation system 104 is illustratively configured to support the visualization, modeling, emulation, and/or simulation of a real world industrial system, such as, but not necessarily limited to, a manufacturing, material handling or logistics system. One specific example of a simulation system 104 is the Flexsim simulation software package currently marketed by Flexsim Software Products, Inc. of Orem, Utah.

Traditionally, as is indicated by dotted block 108, functionally integrating simulation system 104 with control system 102 requires implementation of one or more software drivers 109 that are specific to the type of control system 102 being used (e.g., OPC, DDE Servers, etc.). Drivers 109 are shown in FIG. 1 as being outside of computing device 103 but, in reality, they would be be most commonly implemented from within the computing device environment. Regardless of the details of implementation, integrating a different control system with the same simulation system generally requires installing and configuring a different set of software drivers configured to support the different control system.

In accordance with one aspect of the present invention, an integration system 106 includes a hardware component 110 and a software component 112 that function together to provide a more flexible and convenient alternative to traditional integration support 108. However, it is to be understood that it is within the scope of the present invention that integration system 106 can be configured, if desired, to operate drivers 109. Further, in one embodiment, integration system 106 incorporates an open architecture that is configured to support the use of other services as well, such as Modbus, Direct Relay Logic, RS-232, Sockets and others. In general, the specific implementation details of integration system 106 provided herein should not be considered to exclude incorporation of functionality associated with more traditional drivers and services.

Hardware component 110 enables control system 102 (e.g., a PLC) to be in direct wired communication with the computing device 103 upon which simulation system 104 (e.g., a PC-simulation) is operatively installed. As is indicated by optional configuration box 114, component 110 also or alternatively enables direct wired communication between one or more non-simulated system component and the computing device 103 upon which the simulation system 104 is operatively installed.

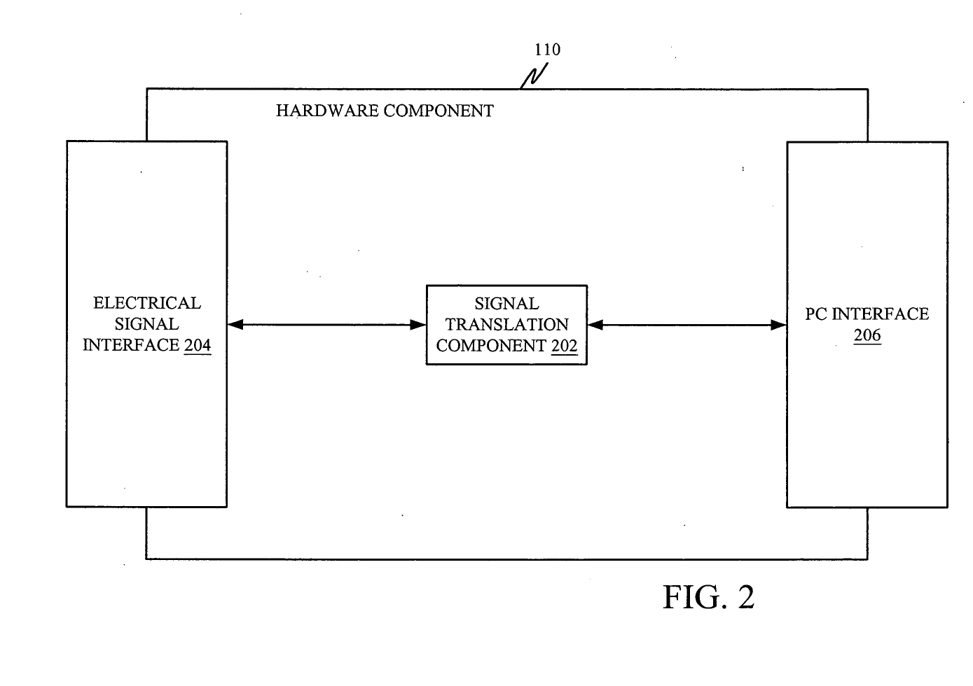

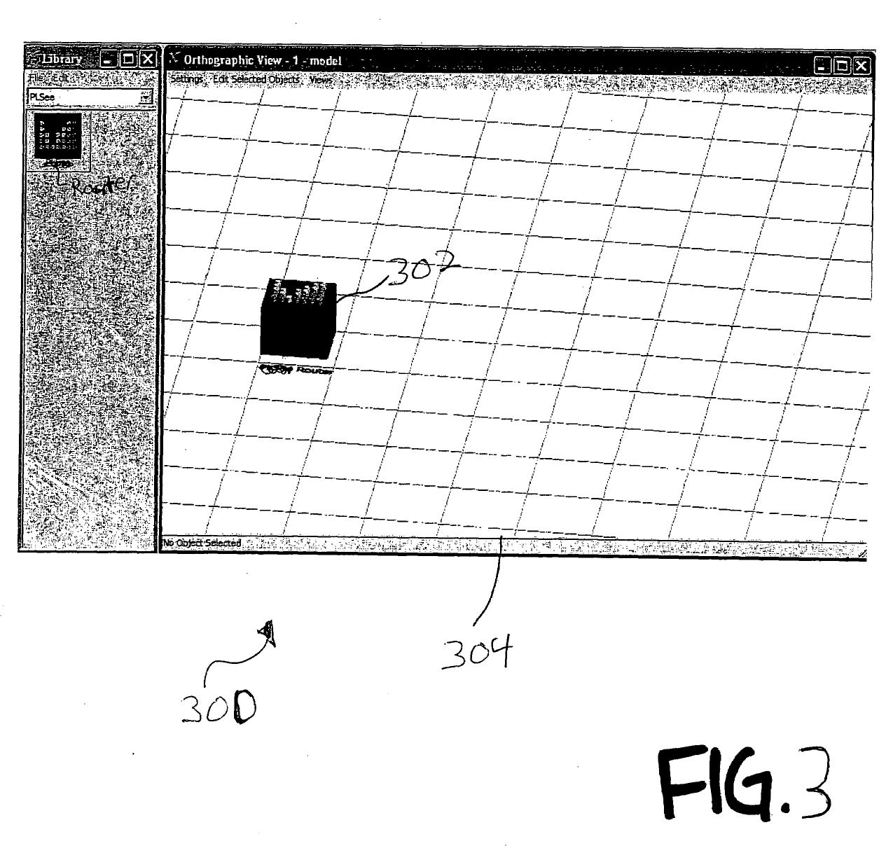

FIG. 2 is a schematic diagram of an example implementation of the hardware component 110. Component 110 includes a signal translation component 202 that operates between an electrical signal interface 204 and a PC interface 206. On a high level, hardware component 110 operates as a translator of sorts between control system 102 (e.g., a PLC) and computing device 103 with the associated simulation system 104 (e.g., a PC/simulation). In addition or alternatively, hardware component 110 operates as a translator of sorts between a non-simulated system component(s) 114 and the computing device 103 with its associated simulation system 104. With that in mind, signal translation component 202 is configured to receive electrical signals (e.g., from a PLC, or directly from control components such as sensors, relays, etc.) and convert them into signals that are appropriate for the PC. The converted signals are transferred to the PC through PC interface 206 (e.g., a USB interface, a serial interface, an interface designed to connect to a specialized PC card, etc.).

In one embodiment, hardware component 110 includes a box with a portion that can be removed to expose internal components. The box also illustratively includes an opening through which a PC interface is exposed (e.g., an opening exposing a female USB port connector). The box also illustratively includes one or more openings through which is exposed a plurality of connectors for receiving, for example, copper wires. The circuitry inside the box is illustratively configured to convert received electrical signals into corresponding PC signals, and to communicate the converted signals through the PC interface. As will be described in more detail below, the circuitry is also configured to operate in the opposite direction (i.e., receive PC signals and convert into corresponding electrical signals that are communicated through the electrical interface).

In accordance with one aspect of the present invention, hardware component 110 can be configured to support any of a broad range of different technical specifications. A particular version of component 110 might be more or less desirable dependent upon the requirements of a given implementation. Further, a given version of hardware component 110 might be, dependent upon the requirements of a given implementation, configured to support particular voltage requirements, polarity requirements, interface requirements, etc. In addition or alternatively, different boxes illustratively may have different relay configurations. Those skilled in the art will appreciate that these and other technical adjustments can be made without departing from the scope of the present invention.

Once computing device 103 receives the converted electrical signals, the next step is to interpret those signals and convert them into a format that is appropriate for simulation system 104. In one embodiment, software component 112 is configured to facilitate this signal interpretation and conversion process.

It should also be pointed out that the described communication scheme is operable in both directions. For example, a signal from the simulation system 104 (e.g., a signal indicating that a package blocked a photo eye in the simulated world) can be transferred to software component 112. The software component is then configured to interpret that signal and convert it into a corresponding raw signal. The converted corresponding raw signal may be transferred through the PC interface to hardware component 110. The hardware component is illustratively configured to translate the signal and forward corresponding electrical signals to an appropriate destination (e.g., to a non-simulated industrial control component, to control system 102, etc.).

It is within the scope of the present invention for integration system 106 to be alternatively implemented without hardware component 110. In one embodiment of such a scenario, a source (e.g., control system 102 and/or a non-simulated control component 114) is directly connected to computing device 103. For example, the control system or non-simulated control component can be connected to the computing device through a computer network interface (e.g., a PLC and/or a non-simulated component can be equipped with an ethernet interface that enables communication with computing device 103 through a network). In this case, a signal is illustratively transferred directly to software component 112. Then, similar to the hardware embodiment, the signal is interpreted and converted into a corresponding signal consistent with an expectation of the simulation software. Of course, this conversion process can again go in both directions.

The software-only embodiment is somewhat similar to the hardware-implemented embodiment. The interface is the primary difference. In one case, the control system and/or non-simulated component signals are transferred through a network interface. In the other case, the signals are transferred through an electrical hardware interface. In accordance with one embodiment, software component 112 is configured to support both alternatives. In terms of network interface support, the software component can be configured to support any network interface such as an ethernet interface, but certainly not limited to an ethernet interface. In one embodiment, software component 112 is extensible in that it can be configured to support any physical connection such as, but certainly not limited to, a USB, Relay Logic, or RS-232 connection. Also, in one embodiment, software component 112 is extensible in that it can be configured to support any communication protocol such as, but not limited to a Modbus, Profibus or OPC protocol.

In one embodiment, software component 112 is configured such that, when a signal is received from simulation system 104 (e.g., a signal associated with a simulated comonent), a target-appropriate signal is generated. The format of the signal is selected based on the requirements of the target for communication. For example, if the target is a PLC, the format is different than it would if the target were a non-simulated system component. It is within the scope of the present invention for software component 112 to facilitate communication in this manner.

Accordingly, in one embodiment, software component 112 is configured to support digital input/output directly in a non-simulated environment. Thus, control system 102 is not necessarily required to control non-simulated input and output devices. Simulation system 104 operating on a computing device 103 can essentially be utilized as a substitute for control system 102 (e.g., a substitute for a logic controller). Accordingly, in one aspect of the present invention, a software simulation is utilized to control an actual conveyor system (or some other industrial component) without a PLC or any other similar control system.

The description will now turn, at least briefly, to a unified modeling language description of an example of software objects that can be implemented as part of the functionality of software component 112. In the following example, the primary object is PLSee. This is illustratively where the bulk of the processing is done. In one embodiment, not by limitation, the “SeaIO8206” is a module configured to translate signals to and/or from hardware component 110 (e.g., signals from the hardware component are translated into signals that simulation system 104 understands). In one embodiment, not by limitation, the “WagoIO” is a module that translates signals to and/or from a communication protocol source (e.g., signals received in a MODbus protocol format are translated into signals that simulation system 104 can understand). The other noted software components are supporting object descriptions that compliment the major objects. Those skilled in the art will appreciate that the following is but one example of many software implementations that should be considered within the scope of the present invention. The specific software configuration details are likely to vary depending on the requirements and preferences associated with a given implementation.

PLSee
+numInputs : int
+numOutputs : int
+IOType[255] : char
+classPointerSealO : SealO8206 *
+classPointerModbus : WagoIO *
+inputArray[1024] : INPUT
+outputArray[1024] : OUTPUT
+PLSee( )
+~PLSee( )
+PLSee(in IOType : char*)
+InitlO(in parm1:char*, in parm 2:char*, in parm3:char*, in
parm 4 : char*) : int
+SetInputInfo(in OutputNumber:int, in InPutTag: char*, in
InputName: char*) : int
+SetOutputInfor(in OutputNumber: int, in OutputTag: char*,
in OutputName: char*) : int
+getErrorText( ) : char*
+EnergizeOutput(in outputNumber:int) : int
+EnergizeOutput(in outputName:int) : int
+DeEnergizeOutput(in outputNumber:int) : int
+DeEnergizeOutput(in outputName:int : int
+PulseOutput(in outputNumber:int, in Duration:int) : int
+PulseOutput(in outputName: char*, in Duration:int) : int
+PulseOutputAsync(in outputNumber:int, in Duration:int):int
+PulseOutputAsync(in outputName:char*, in Duration:int):int
+GetOutputStatus(in outputNumber:int): bool
+GetOutputStaus(inoutputName:char*): bool
+getInstanceNumber(in theName: char*) : int
+GetInputStatus(in inputNumber:int): bool
+GetInputStatus(in inputName:char*): bool
+InPutReceivedCallbackSealO(in Origin: SealO8205*, in
Input: int, in instance: int)
+InputReceivedCallbackModbus(in Origina:WagoIO*, in
Input:int, in instance: int)
PulseSpec
+SI:SealO8206
+Relay:int
+PulseWidth:int
PulseSpecw
+SI:WagoIO
+Relay:int
+PulseWidth:int
SealO8206
+MessageHandlerThredHandle:uintptr_t
+SD:HANDLE
+InputReceivedCallBack:void(*)(SealO8206*,int)
+ErrorCallBack:void(*)(SealO8206*)
+MessageHandler:void(*)(void*)
+SleepCycle: unsigned long
+IBC: _unnamed_3515a4c2_1
+IBP: _unnamed_3515a4c2_1
+CSC:int
+PulseWidth[8]:int
+PulseOff[8]:int
−Error:int
−ErrorText[512]:char
−ClassID[50]:char
−TimeLimit:time_t
−InputSync:CRITICAL_SECTION
−OutputSync:CRITICAL_SECTION
+SealO8206(in DeviceID:int, in ID:char*)
+SealO8206( )
+InitInstance(in DeviceID:char*, in port:char*, in ID:
char*, in parm4:char*):int
+−SealO8206( )
+EnergizeRelay(in Relay:int):int
+DeEnergizeRelay(in Relay:int):int
+PulseRelay(in Relay:int, in msPulseWidth:int):int
+PulseRelay(inRelay:int, in msPulseWidth:int, in
msOffTime:int):int
+PulseRelayAsync(in Relay:int, in msPulseWidth:int):int
+SetPulseWidth(in Relay:int, in msPulseWidth:int):int
+SetPulseOffTime(in Relay:int, in msPulseWIdth:int):int
+StartMessageHandler(inmsSleepCycle:int):int
+StopMessageHandler( ):int
+GetPulseEventCount(in Input:int):int
+InputEvent(in Input:int):int
+AcknowledgeInputEvent(in Input:int):int
+AcknowledgeInputEvent(in Input:int, in DecrementValue :
int):int
+CountInputEvents(in OnOff:int):int
+GetLastError( ):int
+GetLastErrorTest( ):char*
+RegisterInputReceivedCallBack (in cb:void(*)(SealO8206*,
int))
+RegisterErrorCallBack(in cb:void(*)(SealO8206*))
+GetError( ):int
+GetErrorText( ):char*
SetError(in Error:int)
SetERrorText(in Text:char*)
+GetClassID( ):char*
+SetCLassID(in ID:char*):int

<<utility>>Utility

+PLSeeArray[1024]:PLSee*
+myCallbackSealO(in Origin:SealO8206*, in Input:int)
+myCallbackModBUs(in Origin: WagoIO*, in Input:int)

<<struct>>tagADAPTER_INFO

+dwReserved0: DWORD
+dwReserved1: DWORD
+dwReserved2: DWORD
+ucReserved0: UCHAR
+ucReserved1: UCHAR
+ucDigitalToAnalogChannelCount: UCHAR
+ucAnalogToDigitalChannelCount: UCHAR
+dwStateCapabilities: DWORD
+wCardNumber: WORD
+wBaseI0: WORD
+ucPortInCount: UCHAR
+ucPortOutCount: UCHAR
+ucPortCount: UCHAR
+ucEnabled: UCHAR
+wIRQ: WORD
<<datatypes>>ADAPTER_INFO

<<struct>>tagADAPTER_STATE

+infoBits: _unnamed12b4ca9c_1
+dwOutputPreset: DWORD
+dwInterruptBufferSize: DWORD
+dwInterruptControlWord: DWORD
+dwSampleInterval: DWORD
+ucModeCW[9]: UCHAR
+ucAIRange[8]: UCHAR
<<datatype>>ADAPTER_STATE
<<enumeration>>AccessMode
+Relative
+Absolute
WagoIO
+MessageHandlerThredHandle: uintptr_t
+InputReceivedCallBack: void(*)(WagoIO*, int)
+ErrorCallBack: void(*)(WagoIO*)
+MessageHandler:void(*)(void*)
+AvailableOutputs:int
+AvailableAnalogOutputs:int
+AvailableAnalogInputs:int
+AvailableInputs:int
+SleepCycle: unsigned long
+IBC: _unnamed_8ace0e55_1
+IBP: _unnamed_8ace0e55_1
+CSC:int
+PulseWidth[1024]:int
+PulseOff[1024]:int
+Socket: SOCKET
−Error:int
−ErrorText[512]:char
−ClassID[50]: char
−HostName[512]: char
−ResolvedName[512]:char
−TimeLimit: time_t
−WSADataStructure: WSAData
−IOSync: CRITICAL_SECTION
+WagoIO(in Host:char*, in Port:int, in ID:char*)
+WagoIO( )
+−WagoIO( )
+InitInstance(in Host:char*, in port:char*, in ID: char*,
in parm4: char*): int
+EnergizeRelay(inRelay:int):int
+DeEnergizeRelay(in Relay:int):int
+PulseRelay(in Relay:int, in msPulseWidth:int):int
+PulseRelay(in Replay:int, in msPulseWidth:int, in
msOffTime:int):int
+PulseRelayAsync(in Relay:int, in msPulseWidth:int):int
+SetPulseWidth(in Relay:int, in msPulseWidth:int):int
+SetPulseOffTime(in Relay:int, in msPulseWidth:int):int
+StartMessageHandler(in msSleepCycle:int):int
+StopMessageHandler( ):int
+GetPulseEventCount(in Input:int):int
+InputEvent(in Input:int):int
+AcknowledgeInputEvent(in Input:int):int
+AcknowledgeInputEvent(in Input:int, in DecrementValue:
int):int
+CountInputEvents(in OnOff:int):int
+GetAvailableOutputs( ):int
+GetAvailableInputs( ):int
+GetLastError( ):int
+GetLastErrorText( ):char*
+RegisterInputReceivedCallBack (in cb:void(*)(WagoIO*,int))
+RegisterErrorCallBack(in cb:void(*)(WagoIO*))
+GetError( ):int
+GetErrorText( ):char*
+SetError(in Error:int)
+SetErrorText(in Text:char*)
+GetClassID( ):char*
+SetClassID( ):char*
+ReadCoil(in BaseAddr:int):int
−StartTCPServices( ):int
−ConnectEndPoint(in HostName:char*, in Port:int):int
−DisconnectEndPoint( ):int
−ReadRegister(in UpperByte:char, in LowerByte:char):int
−WriteCoil(in RefNum:int, in OffOn:int):int
−HexToHex (inout z: char)
−HexToInt (in Stringln: char*):int
−MBErrorHandling (in errorCode:char):int

In one aspect of the present invention, simulation system 104 is configured to support the functionality of integration system 106. FIG. 9 is an example of a screen shot 300 illustratively associated with system 104. Screen shot 300 demonstrates how the functionality of integration system 106 might be presented to a user of simulation system 104. A router 302 is shown in screen shot 300. Generally speaking, router 302 is a representation of the functionality of integration system 106 within a simulated environment. In other words, the area within a box 304 is the simulated environment and router 302 is a representation of the integration system within that environment.

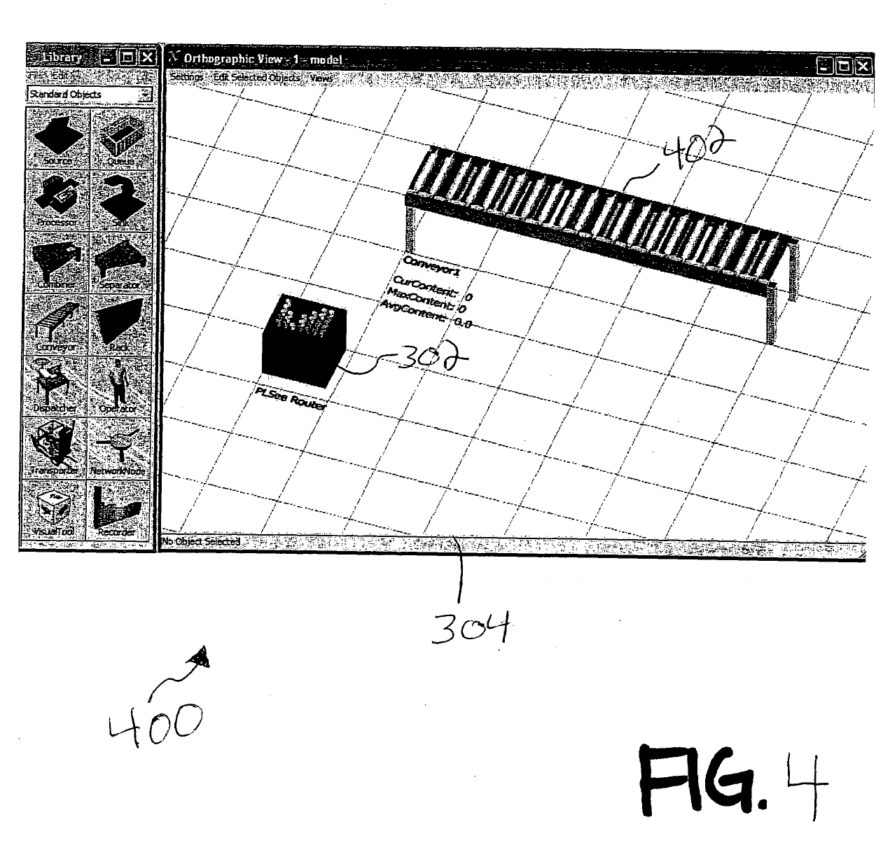

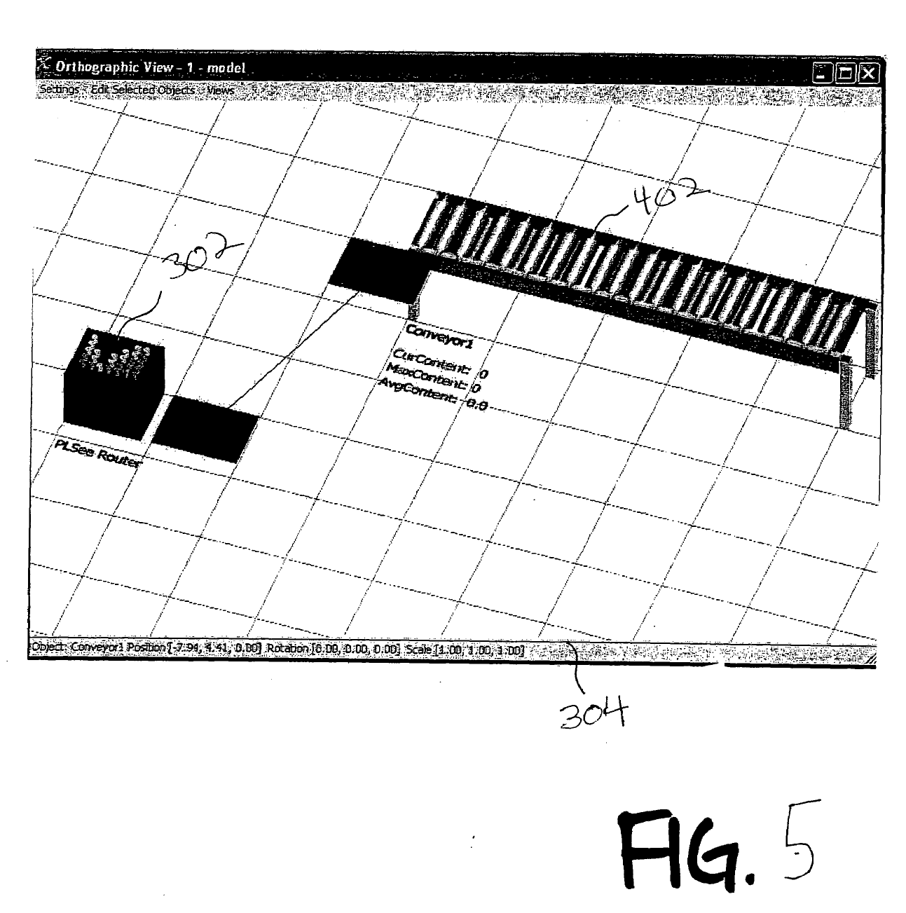

FIG. 4 is example of a screen shot 400 illustratively associated with system 104. Screen shot 400 is similar to screen shot 300 but also includes a section of conveyer 402 in the simulated environment. FIG. 4 is intended to demonstrate a component can be pulled into the work area. Then, connections can be made between router 302 and the simulated components. For example, FIG. 5 shows that router 302 functionality (e.g., the software component 112 objects) has been connected to the conveyer 402. In one embodiment, once connected, electrical signals generated in a non-simulated environment (e.g., by non-simulated component 114, by a control system 102, etc.) will come into the router system and be communicated to the simulated conveyer object. The simulation system 104 is illustratively configured to manipulate simulated items accordingly (e.g., the simulation system initiates a simulated mechanical response based on a signal received from a control system 102 or a non-simulated component, etc.).

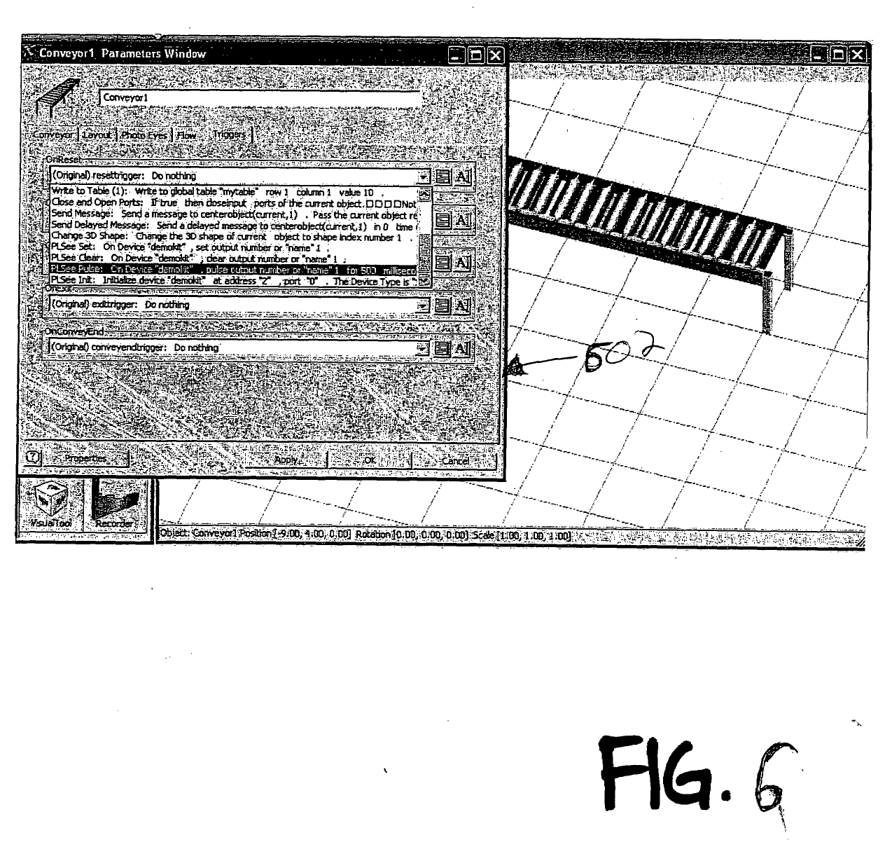

In one embodiment, if a user selects (e.g., “clicks on”) conveyer 402 in FIG. 5, a conveyer parameters window will appear. FIG. 6 shows an example of a conveyer parameters window 602. In one embodiment, in this window, a user can configure the system such that signals from a simulated device (e.g., the simulated conveyer) are transferred out to a non-simulated environment (e.g., to a control system 102 or a non-simulated component 114, etc.) through the software component 112 and/or hardware component 110. In FIG. 12, the user has selected a “pulse” function for the conveyer. In one embodiment, this function enables an electrical signal to be created and then terminated after a predetermined about of time (assumedly, the pulsing would occur upon occurrence of a predetermined event).

An example list of commands that are illustratively supported includes, but is not limited to:

### 1. Initialize Device

This command enables a user to link a specified device at a given address and port. DEVICETYPE can be one of SEAIO8206, MODBUS, OPC, etc. An illustrative command calling format is (char *devicetype, char *deviceaddress, char *deviceport, char *devicename). It should be noted that DEVICENAME is the name to be used in other functions to identify the specific device. An example command call is:
InitializeDevice(“SEAIO8206”,2,0,“demokit”)

### 2. Energize Output By Name

This command enables/energizes a specified output on a specified device by name. An illustrative command calling format is (char *PLSeeDeviceName, char *OutputName). An example command call iS:
EntergizeoutputByName(“demokit”,“motor1”)

### 3. Pulse Output By Number

This command enables/energizes a specified output on a specified device by output number, then disables/de-energizes the same output after a pulse time. An illustrative command calling format is (char *PLSeeDeviceName, int OutputNumber, int PulseTimeMillisedonds). An example command call is:
PulseOutputByNumber(“demokit”,6,500)

### 4. De-energize Output By Name

This command disables/de-energizes the specified output on the specified device by name. An illustrative command calling format is (char *DeviceName, char*OuputName). An example command call is:
DeEnergizeoutputByName(“demokit”,“motor1”)

### 5. De-energize Output By Number

This command disables/de-energizes the specified output on the specified device by number. An illustrative command calling format is (char *DeviceName, int OuputNumber). An example command call is:
DeEnergizeoutputByNumber(“demokit”,6)

### 6. Energize Output By Number

This command enables/energizes the specified output on the specified device by output number. An illustrative command calling format is (char *DeviceName, int OuputNumber). An example command call is:
EnergizeoutputByNumber(“demokit”,6)

### 7. Pulse Output By Name

This command enables/energizes a specified output on a specified device by output name, then disables/de-energizes the same output after a pulse time. An illustrative command calling format is (char *PLSeeDeviceName, char *OutputName, int PulseTimeMillisedonds). An example command call is:
PulseOutputByName(“demokit”,“motor1”,500)

Other commands could include a set input name command for setting an input name, as well as a set output name for setting an output. The commands and command format provided herein are only examples of what those skilled in the art will understand to be a broad range of potential commands. Inclusion and exclusion of certain commands will vary depending on implementation details. Further, in one embodiment, there is a method in the software that supports execution of one or more of the software component functions without requiring code to be written from scratch. In other words, it is within the scope of the present invention for the calling of functions to be intuitively supported in a manner that makes sense to a non-programmer.

What is claimed is:

1. A computer implemented method of facilitating communication within an industrial application environment, the method comprising:
receiving a signal from an industrial application simulation system; and
converting the signal into a different format that is recognizable by a component that is outside of the industrial application simulation system.

2. The method of claim 1, wherein converting the signal into a different format that is recognizable by a component comprises converting the signal into a different format that is recognizable by a programmable logic controller.

3. The method of claim 1, wherein converting the signal into a different format that is recognizable by a component comprises converting the signal into a different format that is recognizable by a component that is independent of the industrial application simulation system.

4. The method of claim 1, wherein converting the signal into a different format that is recognizable by a component comprises converting the signal into a different format that is recognizable by a component that is implemented on a computing device that is different than a computing device upon which the industrial application simulation system is implemented.

5. The method of claim 1, wherein receiving a signal comprises receiving a signal that is indicative of an event that occurs within a simulated industrial application simulated by the industrial application simulation system.

6. The method of claim 1, wherein converting the signal into a different format that is recognizable by a component comprises converting the signal into a different format that is recognizable by non-simulated industrial application.

7. The method of claim 1, wherein converting the signal into a different format that is recognizable by a component comprises converting the signal into a different format that is recognizable by a non-simulated industrial device having a mechanical functionality.

8. The method of claim 1, wherein converting the signal into a different format that is recognizable by a component comprises converting the signal into a different format that is recognizable by a non-simulated industrial device having an electronic functionality.

9. The method of claim 1 further comprising communicating the converted signal to a hardware component configured to convert the converted signal into a format appropriate for transmission through an electrical interface.

10. The method of claim 1, wherein receiving a signal comprises receiving a signal indicative of a command input by a user.

11. The method of claim 1, wherein receiving a signal comprises receiving a signal indicative of a command input by a user into the industrial application simulation system.

12. The method of claim 1, wherein receiving a signal comprises receiving a signal indicative of an output associated with a non-simulated device.

11. An industrial application simulation system, comprising a hardware component configured to facilitate communication between a simulation system operating on a computing device and a non-simulated component.

12. The system of claim 11, wherein the non-simulated component is a programmable logic controller.

13. The system of claim 11, wherein the non-simulated component is a mechanical device.

14. The system of claim 11, wherein the hardware component is configured to convert a signal received from the computing device into a format appropriate for transmission to the non-simulated component by way of an electrical communication interface.

15. The system of claim 11, further comprising a software component configured to facilitate communication between the hardware component and the simulation system.

16. The system of claim 15, wherein the software component includes a translation layer configured to convert a signal received from either the hardware component or the simulation system into a different format.

17. A computer implemented method within an industrial application environment, the method comprising:
receiving a signal from a non-simulated device; and
based on the signal, changing a state of an industrial application simulation.

18. The method of claim 17, wherein receiving a signal comprises receiving a signal from a programmable logic controller.

19. The method of claim 17, wherein receiving a signal comprises receiving a signal from a non-simulated device.

20. The method of claim 17, wherein the non-simulated device is part of a non-simulated application upon which the industrial application simulation is based.
